(19) United States
(12) Patent Application Publication
(10) Pub. No.: US 2026/0186204 A1
(43) Pub. Date: Jul. 2, 2026

(54) ELECTRONIC DEVICE

(71) Applicant: Advanced Semiconductor Engineering, Inc., Kaohsiung (TW)

(72) Inventor: Wen-Long LU, Kaohsiung (TW)

(73) Assignee: Advanced Semiconductor Engineering, Inc., Kaohsiung (TW)

(21) Appl. No.: 19/002,657

(22) Filed: Dec. 26, 2024

(51) Int. Cl. G02B 6/122; G02B 6/12

(52) U.S. Cl. CPC G02B 6/1225; G02B 2006/121; G02B 2006/1213; G02B 2006/12147; G02B 2006/12166

(57) ABSTRACT

An electronic device is provided. The electronic device includes a first terminal and an optical coupler. The optical coupler includes a first segment, a second segment, and a reflective wall. The first segment is configured to optically couple to the first terminal. The reflective wall separates the first segment from the second segment.

### BACKGROUND

### 1. Technical Field

The present disclosure relates generally to an electronic device.

### 2. Description of the Related Art

Currently, electrical bridging circuits are usually used for signal transmission between chips. However, the electrical bridging circuits, particularly for high-speed transmission, usually include redistribution layers (RDLs), the manufacturing process of RDLs is more complex compared to a wire bond process. In addition, signal transmission using electrical bridging circuit results in high signal loss compared to optical transmission.

### SUMMARY

In one or more arrangements, an electronic device includes a first terminal and an optical coupler. The optical coupler includes a first segment, a second segment, and a reflective wall. The first segment is configured to optically couple to the first terminal. The reflective wall separates the first segment from the second segment.

In one or more arrangements, an electronic device includes a terminal and an optical coupler. The terminal is connected to the optical coupler. The optical coupler includes a first segment and a second segment. The first segment defines an enclosed space configured to optically couple to the terminal. The second segment defines an open space communicating with an exterior.

In one or more arrangements, an electronic device includes a first terminal, a second terminal, and an optical channel. The first terminal is adjacent to the second terminal. The optical channel defines a vacuum passage configured to transmit an optical signal to optically couple the first terminal to the second terminal.

### BRIEF DESCRIPTION OF THE DRAWINGS

Aspects of the present disclosure are better understood from the following detailed description when read with the accompanying drawings. It is noted that various features may not be drawn to scale, and the dimensions of the various features may be arbitrarily increased or reduced for clarity of discussion.

FIG. 1 is a cross-section of an electronic device in accordance with some arrangements of the present disclosure.

FIG. 1A is a cross-section of a portion of an electronic device in accordance with some arrangements of the present disclosure.

FIG. 1B is a cross-section of a portion of an electronic device in accordance with some arrangements of the present disclosure.

FIG. 1C is a cross-section of a portion of an electronic device in accordance with some arrangements of the present disclosure.

FIG. 1D is a cross-section of a portion of an electronic device in accordance with some arrangements of the present disclosure.

FIG. 1E is a cross-section of a portion of an electronic device in accordance with some arrangements of the present disclosure.

FIG. 1F is a cross-section of a portion of an electronic device in accordance with some arrangements of the present disclosure.

FIG. 2A is a cross-section of an electronic device in accordance with some arrangements of the present disclosure.

FIG. 2B is a cross-section of an electronic device in accordance with some arrangements of the present disclosure.

FIG. 3A, FIG. 3B, FIG. 3C, FIG. 3D, FIG. 3E, FIG. 3F, and FIG. 3G illustrate various stages of an exemplary method for manufacturing an electronic device in accordance with some arrangements of the present disclosure.

FIG. 4A and FIG. 4B illustrate different types of semiconductor package devices in accordance with some arrangements of the present disclosure.

Common reference numerals are used throughout the drawings and the detailed description to indicate the same or similar elements. The present disclosure will be more apparent from the following detailed description taken in conjunction with the accompanying drawings.

### DETAILED DESCRIPTION

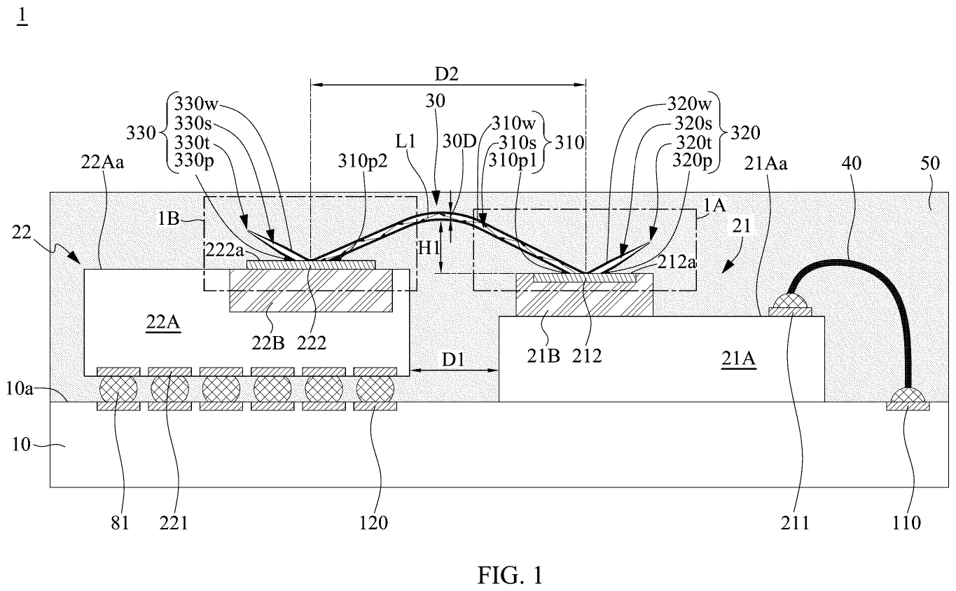

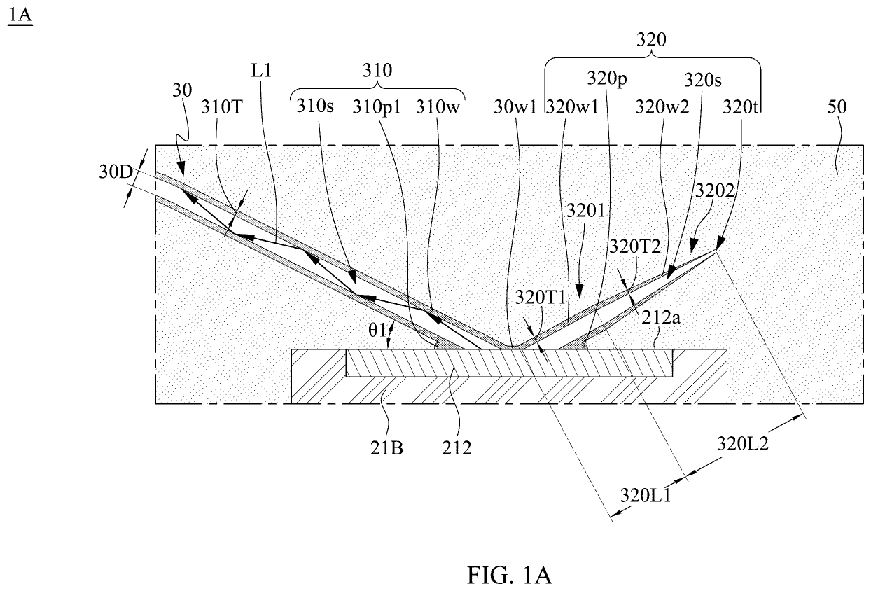

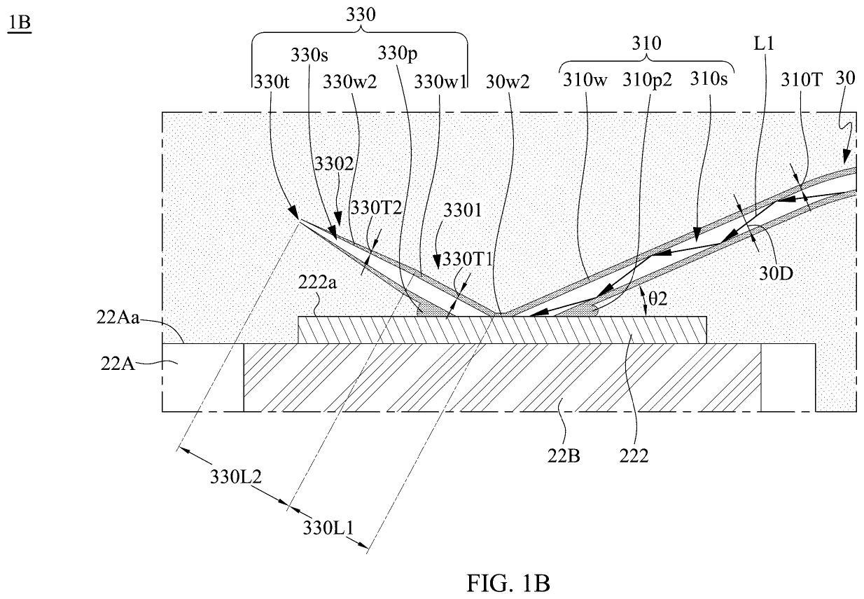

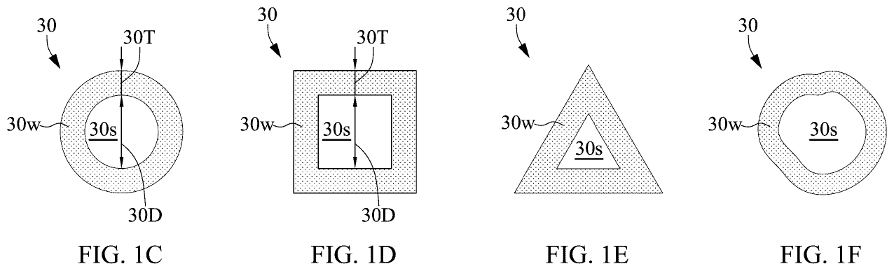

FIG. 1 is a cross-section of an electronic device 1 in accordance with some arrangements of the present disclosure. FIG. 1A is a cross-section of a portion of an electronic device 1 in accordance with some arrangements of the present disclosure. FIG. 1B is a cross-section of a portion of an electronic device 1 in accordance with some arrangements of the present disclosure. In some arrangements, FIG. 1A is a cross-section of a portion 1A of the electronic device 1 in FIG. 1, and FIG. 1B is a cross-section of a portion 1B of the electronic device 1 in FIG. 1. The electronic device 1 may include a carrier 10, components 21 and 22, an optical coupler 30, a conductive wire 40, an encapsulant 50, and electrical contacts 81. In some arrangements, the electronic device 1 may be or include an optoelectronic package.

The carrier 10 may support the components 21 and 22. The carrier 10 may include, for example, a printed circuit board, such as a paper-based copper foil laminate, a composite copper foil laminate, or a polymer-impregnated glass-fiber-based copper foil laminate. The carrier 10 may include an interconnection structure, such as a plurality of conductive traces and a plurality of conductive vias. In some arrangements, the carrier 10 includes a ceramic substrate, a metal plate, an organic substrate, or a leadframe. In some arrangements, the carrier 10 may include a two-layer substrate which includes a core layer and a conductive material and/or structure disposed on an upper surface and a bottom surface of the carrier 10. The conductive material and/or structure may include a plurality of conductive traces. In some arrangements, the carrier 10 includes pads 110 and 120. The pads 110 may be exposed by a surface 10a of the carrier 10. In some arrangements, the pads 110 and 120 are or include electrically conductive pads. The electrically conductive pads may include one or more conductive materials such as a metal or metal alloy. Examples include gold (Au), silver (Ag), aluminum (Al), copper (Cu), or an alloy thereof.

The component 21 may be disposed over and electrically connected to the carrier 10. In some arrangements, the component 21 includes an electronic component 21A, a photonic component 21B, and pads 211 and 212 (also referred to as “terminals”). The pads 211 and 222 are arranged on a front side (e.g., a surface 21Aa) of the electronic component 21A. In some arrangements, the pad 211 is or includes an electrically conductive pad, and the pad 212 is or includes a photonic pad. The photonic pad may be or include an optical waveguide. The pad 211 (or the terminal) may electrically connect the electronic component 21A to an element (e.g., the carrier 10) distinct from the electronic component 21A. In some arrangements, the electronic component 21A is electrically connected to the carrier 10 through the pads 110 and 211. The carrier 10 may support the electronic component 21A and electrically connect to the pad 211 through a conductive element (e.g., the conductive wire 40) adjacent to a lateral side of the electronic component 21A. In some arrangements, the electronic component 21A includes a processing component, e.g., an ASIC, an FPGA, a GPU, or the like, or a combination thereof. In some arrangements, the electronic component 21A includes an electronic integrated circuit (EIC), e.g., a logic circuit, a modulator driver (DRV), a trans-impedance amplifier (TIA), or a combination thereof.

In some arrangements, the photonic component 21B is disposed over a surface 21Aa of the electronic component 21A. In some arrangements, the electronic component 21A includes the photonic component 21B. In some arrangements, the photonic component 21B is optically coupled to the optical coupler 30 through the pad 212 that is exposed by a surface 212a (also referred to as “a coupling surface”) of the pad 212. The photonic component 21B may be configured to provide a photoelectric conversion. In some arrangements, the photonic component 21B is configured to convert an optical signal (e.g., light L1) received from an optical channel of the optical coupler 30 through the pad 212 to an electrical signal and transmit the electrical signal to the electronic component 21A. In some arrangements, the photonic component 21B is configured to convert an electrical signal received from the electronic component 21A to an optical signal (e.g., light L1) and transmit the optical signal to the optical coupler 30 through the pad 212. The photonic component 21B may be or include a photonic integrated circuit (PIC), a laser diode, a receiver, a waveguide, a photodetector, a photodiode, a semiconductor optical amplifier (SOA), a grating coupler, a fiber coupling structure, an optical modulator (e.g., Mach-Zehnder modulator or microring modulator), or a combination thereof. The pad 212 may be referred to as a terminal which is a portion of the electronic component 21A. The photonic component 21B and the pad 212 may be collectively referred to as a terminal.

The component 22 may be disposed over and electrically connected to the carrier 10. In some arrangements, the component 22 includes an electronic component 22A, a photonic component 22B, and pads 221 and 222. In some arrangements, the pad 221 is or includes an electrically conductive pad, and the pad 222 is or includes a photonic pad. In some arrangements, the electronic component 22A is electrically connected to the carrier 10 through the pads 120 and 221 and the electrical contacts 81. In some arrangements, the electronic component 22A includes a processing component, e.g., an ASIC, an FPGA, a GPU, or the like, or a combination thereof. In some arrangements, the electronic component 22A includes an EIC, e.g., a logic circuit, a DRV, a TIA, or a combination thereof. The pad 222 (or the terminal) may be spaced apart from the pad 212 (or the terminal).

In some arrangements, the photonic component 22B is embedded or integrated in the electronic component 22A. In some arrangements, the electronic component 22A includes the photonic component 22B. In some arrangements, the photonic component 22B is optically coupled to the optical coupler 30 through the pad 222 that is exposed by a surface 22Aa of the electronic component 22A and a surface 222a (also referred to as “a coupling surface”) of the pad 222. The photonic component 22B may be configured to provide a photoelectric conversion. In some arrangements, the photonic component 22B is configured to convert an optical signal (e.g., light L1) received from an optical channel of the optical coupler 30 through the pad 222 to an electrical signal and transmit the electrical signal to the electronic component 22A. In some arrangements, the photonic component 22B is configured to convert an electrical signal received from the electronic component 22A to an optical signal (e.g., light L1) and transmit the optical signal to the optical coupler 30 through the pad 222. The photonic component 22B may be or include a PIC, a laser diode, a receiver, a waveguide, a photodetector, a photodiode, a SOA, a grating coupler, a fiber coupling structure, an optical modulator (e.g., Mach-Zehnder modulator or microring modulator), or a combination thereof. The pad 222 may be referred to as a terminal. In some arrangements, the pad 222 (or the terminal) is adjacent to the pad 212 (or the terminal). In some arrangements, the pads 212 and 222 are at different elevations. The photonic component 22B and the pad 222 may be collectively referred to as a terminal. In some arrangements, the photonic component 22B and the pad 222 (or the terminal) are adjacent to the photonic component 21B and the pad 212 (or the terminal) which is a portion of the electronic component 22A. In some arrangements, the photonic components 21B and 22B are at different elevations.

In some arrangements, the components 21 and 22 are spaced apart from each other by a distance D1 from about 5 μm to about 200 μm. In some arrangements, a pitch D2 of the photonic pads (e.g., the pads 212 and 222) is from about 15 μm to about 300 μm.

The optical coupler 30 may be connected to the pads 212 and 222 (or the terminals). In some arrangements, the optical coupler 30 includes a tubular structure. In some arrangements, the optical coupler 30 includes a photonic wire. In some arrangements, the optical coupler 30 includes a wall structure (e.g., walls 310w, 320w, 330w, 30a1, and 30a2) defining the tubular structure, a portion (or the wall 30a1) of the wall structure contacts the surface 212a of the pad 212 (or the terminal), and a portion (or the wall 30a2) of the wall structure contacts the surface 222a of the pad 222 (or the terminal). In some arrangements, the wall 30a1 is bonded to the surface 212a through recrystallization of the materials from the wall 30a1 and the pad 212. In some arrangements, the wall 30a2 is bonded to the surface 222a through recrystallization of the materials from the wall 30a2 and the pad 222. In some arrangements, the wall structure is or includes a reflective wall. In some arrangements, the reflective wall is formed of or includes a non-metal material (e.g., PI, an epoxy-based material, ABF, PP, acrylic acid, or the like), a metal material (e.g., Cu, Au, Ag, Al, Pd, Pt, Ni, stainless steel alloy, or the like), or a combination thereof.

In some arrangements, the optical coupler 30 includes segments 310, 320, and 330. In some arrangements, the optical coupler 30 is configured to optically couple to the pad 212 (or the terminal) and the pad 222 (or the terminal). In some arrangements, the optical coupler 30 is configured to transmit one or more optical signals (e.g., lights L1) to optically couple the pad 212 and/or the photonic component 21B (or the terminal) to the pad 222 and/or the photonic component 22B (or the terminal). In some arrangements, the segment 310 is or includes an optical channel configured to optically couple to the pad 212 (or the terminal) and the pad 222 (or the terminal). In some arrangements, the segments 310 and 320 extend in different directions. The pad 222 (or the terminal) may be spaced apart from the pad 212 (or the terminal) and configured to optically couple to the segment 310.

In some arrangements, the segment 310 defines a space 310s. The space 310s may be an enclosed space or a sealed space. In some arrangements, the space 310s is configured to optically couple to the pads 212 and 222 (or the terminals). In some arrangements, the space 310s is configured to optically couple to the photonic components 21B and 22B (or the terminals). In some arrangements, a portion (or a first portion) of the surface 212a is exposed to the space 310s.

In some arrangements, the segment 310 includes a wall 310w defining the space 310s (or the enclosed space). In some arrangements, the wall 310w is or includes a reflective wall. In some arrangements, the space 310s is vacuum sealed. The vacuum sealed space 310s may be referred to as a vacuum passage. The vacuum passage may be defined by a sealed space (e.g., the space 310s) enclosed by a tubular wall (e.g., the wall 310w) extending between the pad 212 (or the terminal) and the pad 222 (or the terminal). The vacuum passage may be configured to transmit one or more optical signals (e.g., the lights L1) to optically couple the pad 212 and/or the photonic component 21B (or the terminal) to the pad 222 and/or the photonic component 22B (or the terminal). In some arrangements, the pads 212 and 222 (or the photonic pads) are exposed to the vacuum passage. In some arrangements, the segment 310 (or the optical channel) has a loop height H1 from about 5 μm to about 100 μm.

A ratio (C/C₀) of the speed of light in vacuum (C) with respect to the speed of light in a dielectric material (C₀) may be determined by the following equation: C/C₀=1/\sqrt{ }εᵣ. εᵣ is greater than 1 for all materials, and εᵣ is 1 for vacuum. Therefore, the speed of light in vacuum is faster than the speed of light in all materials except vacuum. In view of the above, according to some arrangements of the present disclosure, the optical coupler 30 includes a segment 310 defining a space 310s that is vacuum sealed and configured to transmit an optical signal. Therefore, the optical transmission speed is improved significantly.

In addition, according to some arrangements of the present disclosure, the optical coupler 30 comprises a flexible structure that is capable of being bent or forming a loop. Therefore, the flexible structure allows the optical coupler 30 to bond to terminals (e.g., the pads 212 and 222) at different elevations, and thus the optical coupler 30 can be used to optically couple the components 21 and 22 having different thicknesses/heights and coupling surfaces at different elevations.

In some arrangements, the space 310s is filled with a liquid or a gas. In some arrangements, a refractive index of a medium (e.g., the liquid or the gas) within the space 310s is lower than a refractive index of the wall 310w. In some arrangements, a dielectric constant of a medium (e.g., the liquid or the gas) within the space 310s is lower than a dielectric constant of the wall 310w. In some arrangements, the surface 212a (or the coupling surface) of the pad 212 contacts the liquid. In some arrangements, the surface 222a (or the coupling surface) of the pad 222 contacts the liquid or the gas. In some arrangements, the optical coupler 30 with the space 310s filled with the liquid or the gas is configured to transmit an optical signal (e.g., light L1) to optically couple the pad 212 and/or the photonic component 21B (or the terminal) to the pad 222 and/or the photonic component 22B (or the terminal). The liquid may be or include water, alcohol, benzene, acetone, a combination thereof, or other suitable liquids. The gas may be or include helium (He), hydrogen (H₂), nitrogen (N₂), carbon dioxide (CO₂), a combination thereof, or other suitable gas.

Referring to FIG. 1A, in some arrangements, the wall 310w of the segment 310 has a substantially constant thickness 310T. In some arrangements, the space 310s has a substantially constant width 30D. Lights L1 may be configured to be transmitted within the space 310s of the optical coupler 30. In some arrangements, the segment 310 further includes at least a protrusion 310p1. In some arrangements, the protrusion 310p1 is between the wall 310w and the surface 212a of the pad 212 (or the terminal). In some arrangements, the protrusion 310p1 contacts the wall 310w. In some arrangements, an angle θ1 defined by the segment 310 and the surface 212a (or the coupling surface) of the pad 212 (or the terminal) is from about 1° to about 80°.

Referring to FIG. 1B, in some arrangements, the segment 310 further includes at least a protrusion 310p2. In some arrangements, the protrusion 310p2 is between the wall 310w and the surface 222a of the pad 222 (or the terminal). In some arrangements, the protrusion 310p2 contacts the wall 310w. In some arrangements, an angle θ2 defined by the segment 310 and the surface 222a (or the coupling surface) of the pad 222 (or the terminal) is from about 1° to about 80°.

In some arrangements, the segment 320 defines a space 320s. The space 320s may be an open space communicating with an exterior. The exterior may be referred to an environment or a space outside of the space 320s of the optical coupler 30. In some arrangements, the segment 320 includes a first end connected to the pad 212 (or the terminal) and a second end opposite to the first end and defining a through hole 320t that connects the space 320s to the exterior. In some arrangements, a portion (or a second portion that is different from and spaced apart from the first portion) of the surface 212a is exposed to the space 320s. In some arrangements, the segment 320 is separated from the segment 310 by the wall 30a1 (or the reflective wall).

In some arrangements, the segment 320 includes a wall 320w defining the space 320s (or the open space). In some arrangements, the wall 320w is or includes a reflective wall. In some arrangements, the space 320s is filled with air. In some arrangements, a pressure within the space 310s is lower than a pressure within the space 320s. In some arrangements, the space 310s is filled with a liquid, and the space 320s is filled with air. In some arrangements, the surface 212a of the pad 212 includes a portion exposed to the liquid filled in the space 310s and a portion exposed to the air filled in the space 320s. In some arrangements, the space 320s is filled with the liquid that is filled in the space 310s. In some arrangements, the wall 320w has a thickness decreasing in a direction toward the through hole 320t. In some arrangements, the liquid in the space 320s is exposed to the exterior through the through hole 320t.

Referring to FIG. 1A, in some arrangements, the segment 320 includes a portion 3201, a portion 3202, and a protrusion 320p. The portion 3201 may be referred to as a columnar portion or a tail portion, and the portion 3202 may be referred to as a tapered portion or a necking portion. In some arrangements, the portion 3202 (or the tapered portion) is between the through hole 320t and the portion 3201 (or the columnar portion). In some arrangements, a length 320L2 of the portion 3202 is equal to or greater than a length 320L1 of the portion 3201. In some arrangements, the length 320L1 is from about 1 μm to about 10 μm, and the length 320L2 is from about 1 μm to about 30 μm. In some arrangements, the portion 3201 includes a wall 320w1 having a substantially constant thickness 320T1. In some arrangements, the portion 3202 includes a wall 320w2 having a thickness 320T2 decreasing in a direction toward the through hole 320t. The walls 320w1 and 320w2 collectively construct the wall 320w of the segment 320. In some arrangements, the protrusion 320p is between the portion 3201 and the surface 212a of the pad 212 (or the terminal). In some arrangements, the protrusion 320p contacts the wall 320w1 of the portion 3201.

In some arrangements, the segment 330 defines a space 330s. The space 330s may be an open space communicating with an exterior. The exterior may be referred to an environment or a space outside of the space 330s of the optical coupler 30. In some arrangements, the segment 330 includes a first end connected to the pad 222 (or the terminal) and a second end opposite to the first end and defining a through hole 330t that connects the space 330s to the exterior. In some arrangements, a portion (or a second portion that is different from and spaced apart from the first portion) of the surface 222a is exposed to the space 330s.

In some arrangements, the segment 330 includes a wall 330w defining the space 330s (or the open space). In some arrangements, the wall 330w is or includes a reflective wall. In some arrangements, the space 330s is filled with air. In some arrangements, a pressure within the space 310s is lower than a pressure within the space 330s. In some arrangements, the space 310s is filled with a liquid, and the space 330s is filled with air. In some arrangements, the surface 222a of the pad 222 includes a portion exposed to the liquid filled in the space 310s and a portion exposed to the air filled in the space 330s. In some arrangements, the space 330s is filled with the liquid that is filled in the space 310s. In some arrangements, the wall 330w has a thickness decreasing in a direction toward the through hole 330t.

Referring to FIG. 1B, in some arrangements, the segment 330 includes a portion 3301, a portion 3302, and a protrusion 330p. The portion 3301 may be referred to as a columnar portion or a tail portion, and the portion 3302 may be referred to as a tapered portion or a necking portion. In some arrangements, the portion 3302 (or the tapered portion) is between the through hole 330t and the portion 3301 (or the columnar portion). In some arrangements, a length 330L2 of the portion 3302 is equal to or greater than a length 330L1 of the portion 3301. In some arrangements, the length 330L1 is from about 1 μm to about 10 μm, and the length 330L2 is from about 1 μm to about 30 μm. In some arrangements, the portion 3301 includes a wall 330w1 having a substantially constant thickness 330T1. In some arrangements, the portion 3302 includes a wall 330a2 having a thickness 330T2 decreasing in a direction toward the through hole 330t. The walls 330w1 and 330a2 collectively construct the wall 330w of the segment 330. In some arrangements, the protrusion 330p is between the portion 3301 and the surface 222a of the pad 222 (or the terminal). In some arrangements, the protrusion 330p contacts the wall 330a1 of the portion 3301.

The conductive wire 40 may electrically connect the pad 110 to the pad 211. In some arrangements, the conductive wire 40 electrically connects the pad 212 or the photonic component 21B to the carrier 10. The conductive wire 40 may include, for example, Au, Ag, Cu, nickel (Ni), palladium (Pd), another metal(s) or alloy(s), or a combination of two or more thereof.

The encapsulant 50 may encapsulate the components 21 and 22, the optical coupler 30, the conductive wire 40, and the electrical contacts 81. In some arrangements, the encapsulant 50 encapsulates the pads 212 and 222 (or the terminals). In some arrangements, the encapsulant 50 covers the through holes 320t and 330t without entering the spaces 320s and 330s. In some arrangements, the encapsulant 50 contacts the liquid filled in the space 320s and the liquid filled in the space 330s. The encapsulant 50 may include an epoxy resin having fillers dispersed therein, a molding compound (e.g., an epoxy molding compound or other molding compound), polyimide (PI), a phenolic compound or material, a polymer material with silicone dispersed therein, or a combination thereof.

The electrical contacts 81 may electrically connect the pads 221 to the pads 120. In some arrangements, the electrical contacts 81 are or include solder balls. In some arrangements, the electrical contacts 81 include controlled collapse chip connection (C4) bumps, a ball grid array (BGA), or a land grid array (LGA).

FIG. 1C is a cross-section of a portion of an electronic device in accordance with some arrangements of the present disclosure. FIG. 1D is a cross-section of a portion of an electronic device in accordance with some arrangements of the present disclosure. FIG. 1E is a cross-section of a portion of an electronic device in accordance with some arrangements of the present disclosure. FIG. 1F is a cross-section of a portion of an electronic device in accordance with some arrangements of the present disclosure. In some arrangements, FIG. 1C, FIG. 1D, FIG. 1E, and FIG. 1F show different cross-sections of the optical coupler 30 of the electronic device 1, 2A, and/or 2B.

Referring to FIG. 1C, in some arrangements, the optical coupler 30 includes a wall 30w defining a space 30s to construct a tubular structure. The wall 30w may be the wall 310w of the segment 310, and the space 30s may be the space 310s of the segment 310. In some arrangements, the optical coupler 30 includes a circle-shaped cross-sectional structure, the wall 30w includes a ring-shaped cross-sectional structure with a thickness 30T (e.g., the thickness 310T of the wall 310w), and the space 30s has a circle-shaped cross-section with a width 30D (or a diameter of the circle). In some arrangements, the thickness 30T is from about 10 μm to about 50 μm, and the width 30D is from about 10 μm to about 200 μm. According to some arrangements of the present disclosure, the space 30s having a circle-shaped cross-section can provide a relatively symmetric reflective surface for the optical signal (e.g., the light L1), thus the transmission loss can be reduced, and coupling efficiency can be increased.

Referring to FIG. 1D, in some arrangements, the optical coupler 30 includes a rectangular-shaped cross-sectional structure, the wall 30w includes a rectangular ring-shaped cross-sectional structure with a thickness 30T (e.g., the thickness 310T of the wall 310w), and the space 30s has a rectangular-shaped cross-section with a width 30D.

Referring to FIG. 1E, in some arrangements, the optical coupler 30 includes a triangular-shaped cross-sectional structure, the wall 30w includes a triangular ring-shaped cross-sectional structure, and the space 30s has a triangular-shaped cross-section.

Referring to FIG. 1F, in some arrangements, the optical coupler 30 includes an irregular-shaped cross-sectional structure, the wall 30w includes an irregular ring-shaped cross-sectional structure, and the space 30s has an irregular-shaped cross-section.

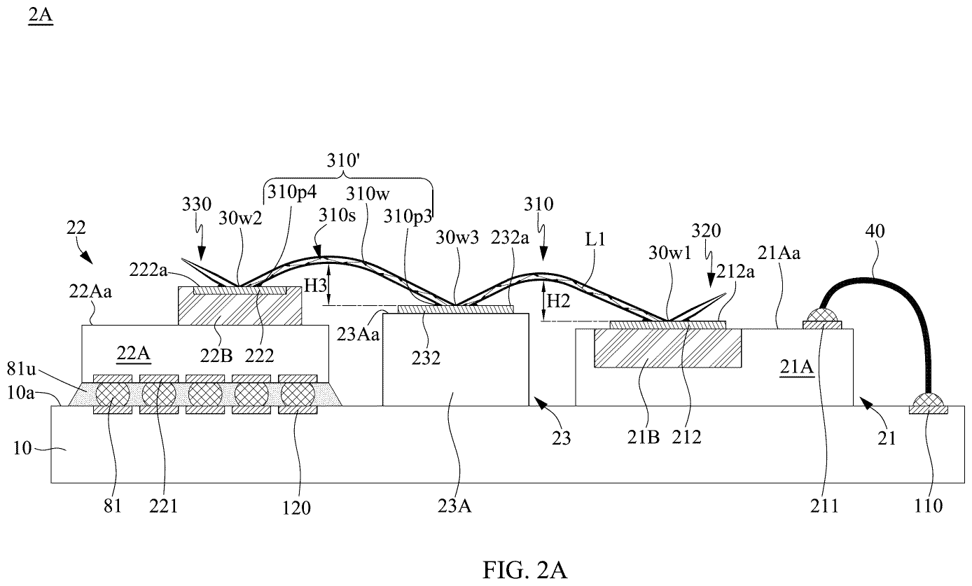

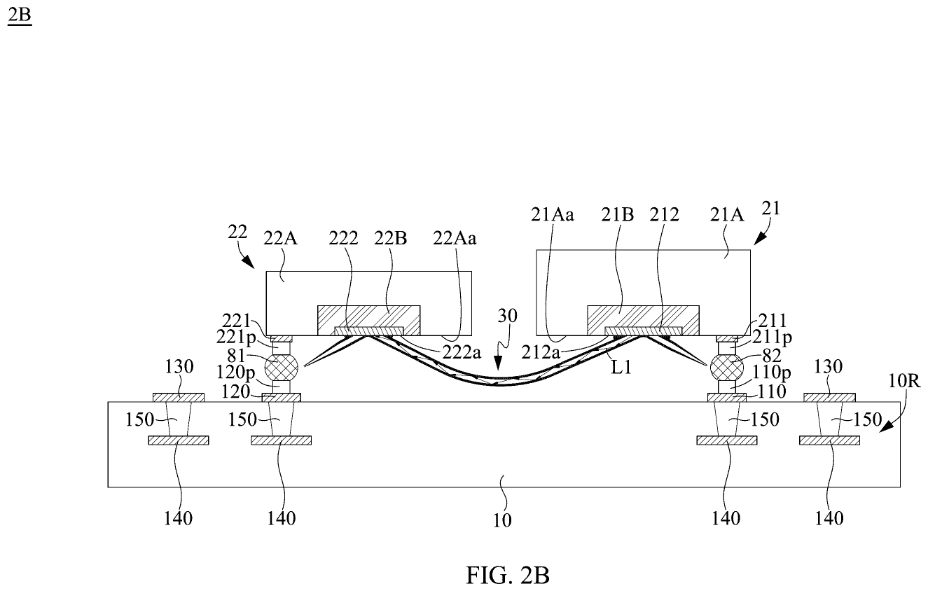

FIG. 2A is a cross-section of an electronic device 2A in accordance with some arrangements of the present disclosure. The electronic device 2A is similar to the electronic device 1, and the differences therebetween are described as follows.

In some arrangements, the electronic device 2A further includes a component 23, and the optical coupler 30 further includes a segment 310′.

In some arrangements, the component 23 includes a substrate 23A and a pad 232. In some arrangements, the pad 232 is or includes a photonic pad. The photonic pad may be or include an optical waveguide. The pad 232 may be referred to as a terminal. The pad 232 may be exposed by a surface 23Aa of the substrate 23A. In some arrangements, the pad 232 is between the pad 212 and the pad 222. In some arrangements, the substrate 23A may include an electronic component including a logic circuit or a dummy element.

In some arrangements, the segment 310′ defines a space 310s. The space 310s may be an enclosed space or a sealed space. In some arrangements, the space 310s is configured to optically couple to the pads 232 and 222 (or the terminals). In some arrangements, the space 310s is configured to optically couple to the photonic components 22B and the pad 232 (or the terminals). In some arrangements, a portion (or a first portion) of the surface 232a of the pad 232 is exposed to the space 310s of the segment 310, and a portion (or a second portion) of the surface 232a of the pad 232 is exposed to the space 310s of the segment 310′.

In some arrangements, the segment 310′ includes a wall 310w defining the space 310s (or the enclosed space). In some arrangements, the space 310s is vacuum sealed. The vacuum sealed spaces 310s of the segments 310 and 310′ may be collectively referred to as a vacuum passage. The vacuum passage may include a first part (e.g., the space 310s of the segment 310) optically coupling the pad 212 to the pad 232, and the vacuum passage may further include a second part (e.g., the space 310s of the segment 310′) optically coupling the pad 232 to the pad 222. In some arrangements, the spaces 310s of the segments 310 and 310′ are spaced apart from each other. In some arrangements, the surface 232a (or the coupling surface) of the pad 232 is exposed to the first part (e.g., the space 310s of the segment 310′) of the vacuum passage. The vacuum passage may be defined by a sealed space (e.g., the space 310s) enclosed by a tubular wall (e.g., the wall 310w) extending between the pad 232 (or the terminal) and the pad 222 (or the terminal). The vacuum passage may be configured to transmit one or more optical signals (e.g., the lights L1) to optically couple the pad 222 and/or the photonic component 22B (or the terminal) to the pad 232 (or the terminal). In some arrangements, the pads 232 and 222 (or the photonic pads) are exposed to the vacuum passage.

In some arrangements, the space 310s of the segment 310′ is filled with the liquid filled in the space 310s of the segment 310. In some arrangements, a refractive index of a medium (e.g., the liquid) within the space 310s is lower than a refractive index of the wall 310w. In some arrangements, a dielectric constant of a medium (e.g., the liquid) within the space 310s is lower than a dielectric constant of the wall 310w. In some arrangements, the surface 232a (or the coupling surface) of the pad 232 contacts the liquid.

In some arrangements, the segment 310′ further includes protrusions 310p3 and 310p4. In some arrangements, the protrusion 310p3 is between the wall 310w and the surface 232a of the pad 232 (or the terminal). In some arrangements, the protrusion 310p4 is between the wall 310w and the surface 222a of the pad 222 (or the terminal).

In some arrangements, the optical coupler 30 includes a wall structure (e.g., walls 310w, 320w, 330w, 30w1, 30w2, and 30w3) defining the tubular structure. In some arrangements, a portion (or the wall 30a1) of the wall structure contacts the surface 212a of the pad 212 (or the terminal), a portion (or the wall 30a2) of the wall structure contacts the surface 222a of the pad 222 (or the terminal), and a portion (or the wall 30w3) of the wall structure contacts the surface 232a of the pad 232 (or the terminal). In some arrangements, the segment 310 (or the optical channel) has a loop height H2 from about 5 μm to about 100 μm, and the segment 310′ (or the optical channel) has a loop height H3 from about 5 μm to about 100 μm.

In some arrangements, the electrical contacts 81 are encapsulated by a protective element 81u. The protective element 81u may be or include an underfill. In some arrangements, the underfill includes an epoxy resin, a molding compound (e.g., an epoxy molding compound or other molding compound), PI, a phenolic compound or material, a material including a silicone dispersed therein, or a combination thereof.

FIG. 2B is a cross-section of an electronic device in accordance with some arrangements of the present disclosure. The electronic device 2B is similar to the electronic device 1, and the differences therebetween are described as follows.

In some arrangements, the carrier 10 includes an interconnection structure 10R including pads 110, 120, 130, and 140 and conductive vias 150 connecting the pads. The pads 110, 120, 130, and 140 may be electrically conductive pads.

In some arrangements, the component 21 is optically coupled to the component 22 through the optical coupler 30. In some arrangements, the component 21 is electrically connected to the carrier 10 through the pads 110 and 211, conductive pillars 110p and 211p, and an electrical contact 82. In some arrangements, the component 22 is electrically connected to the carrier 10 through the pads 120 and 221, conductive pillars 120p and 221p, and an electrical contact 81.

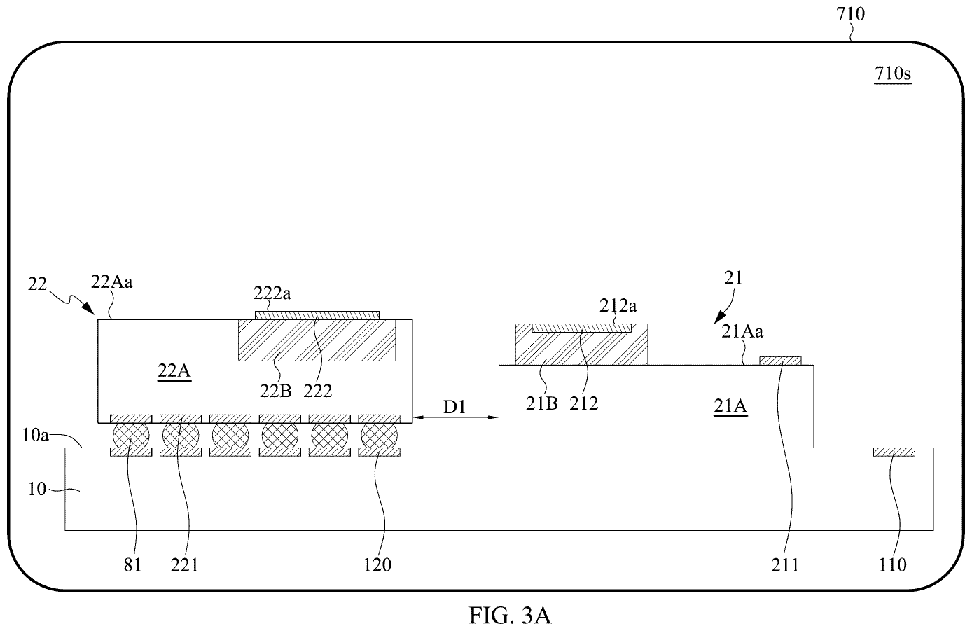

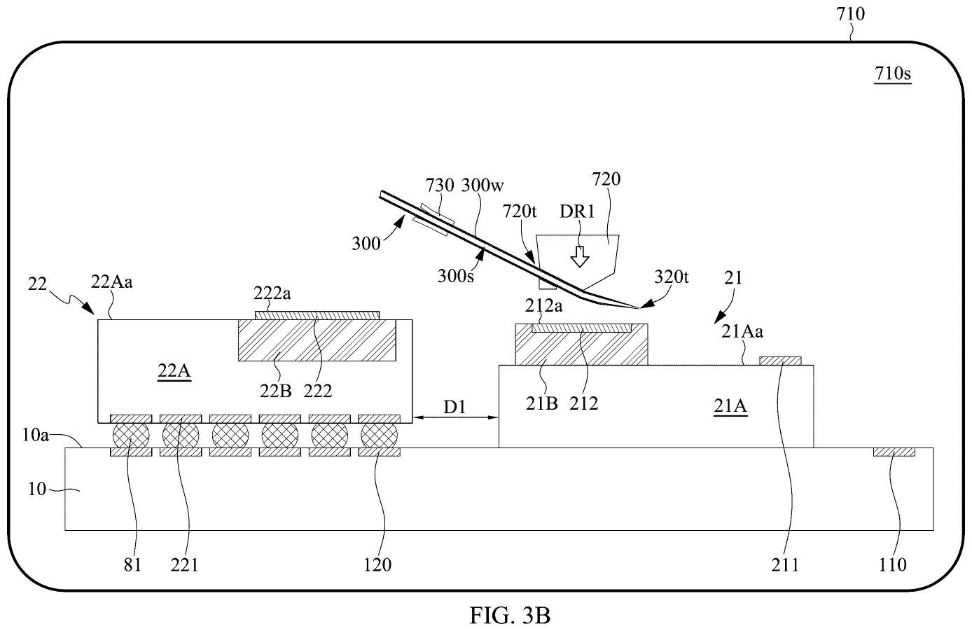

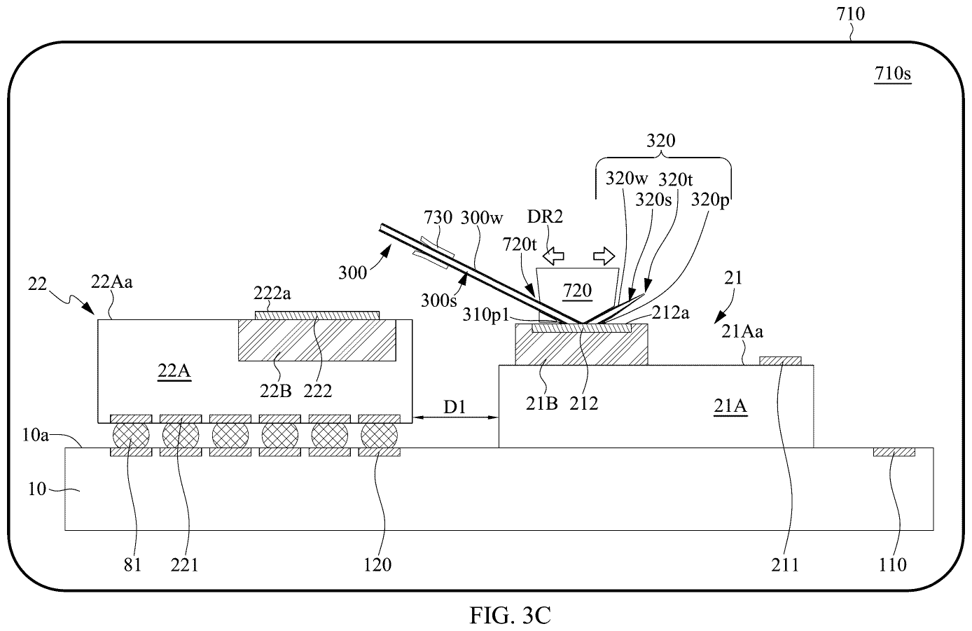

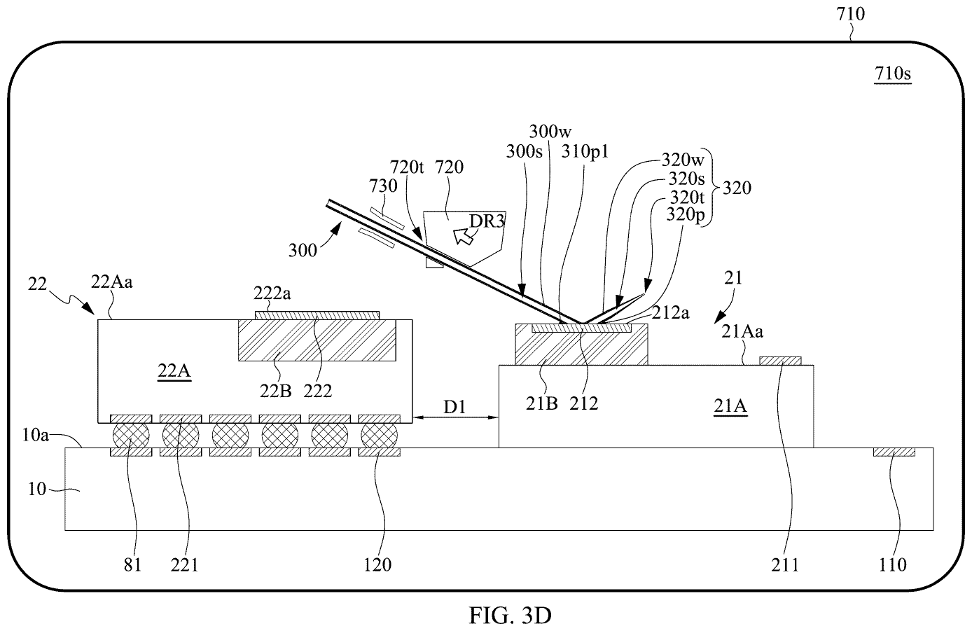

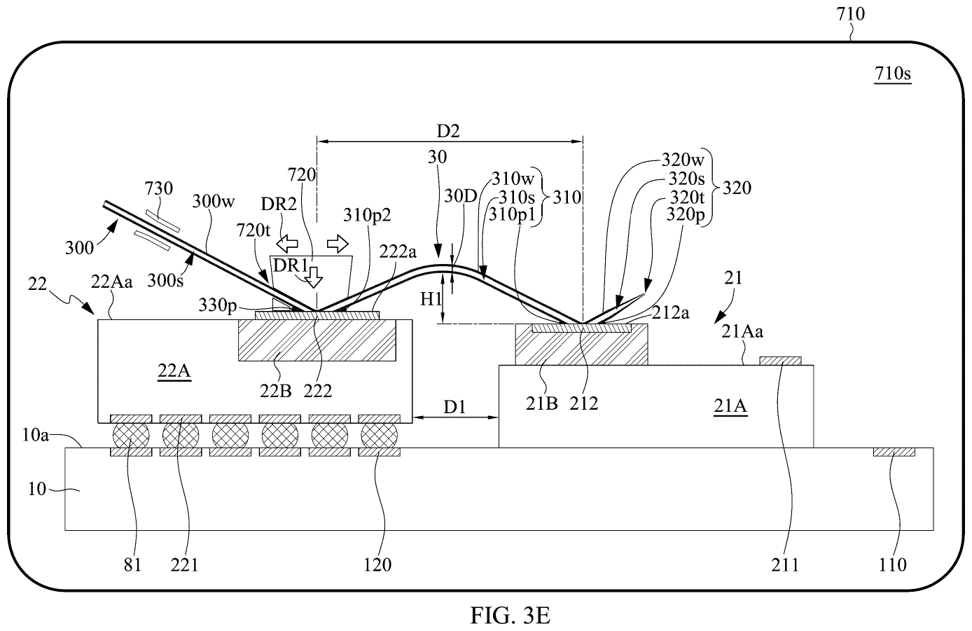

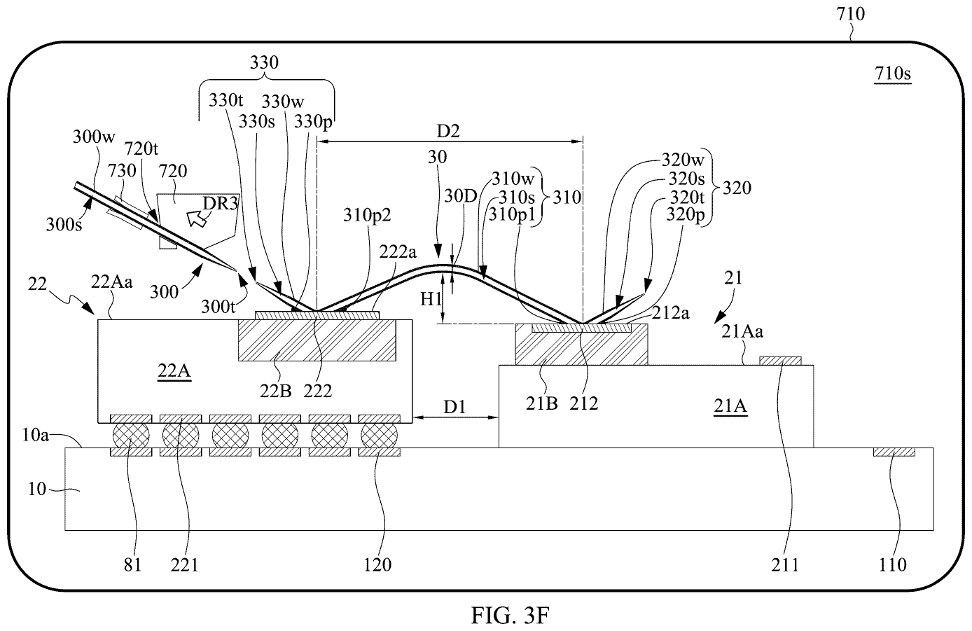

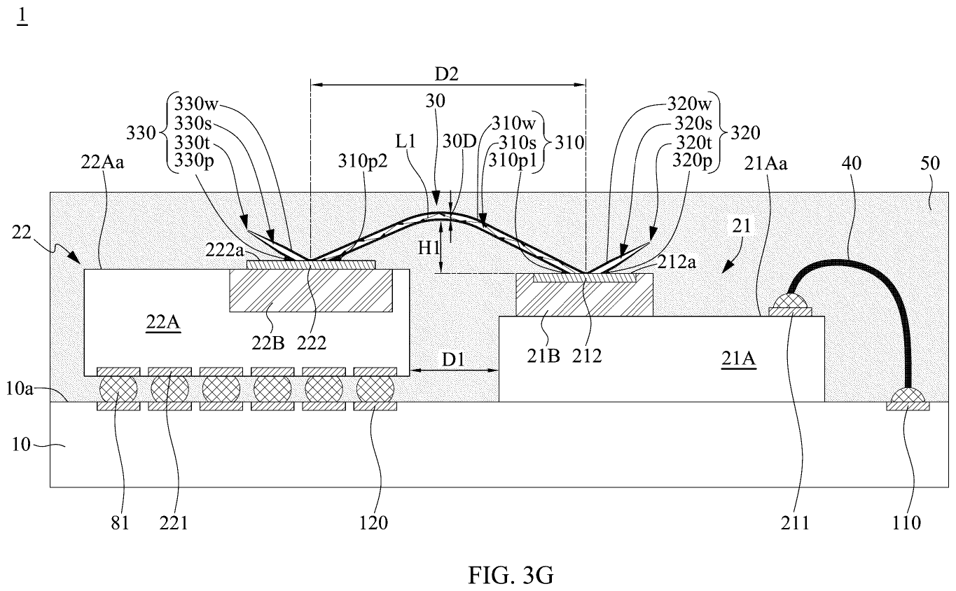

FIG. 3A, FIG. 3B, FIG. 3C, FIG. 3D, FIG. 3E, FIG. 3F, and FIG. 3G illustrate various stages of an exemplary method for manufacturing an electronic device in accordance with some arrangements of the present disclosure.

Referring to FIG. 3A, a chamber 710 defining an inner space 710s may be provided, and an intermediate structure including a carrier 10 with components 21 and 22 disposed thereon may be disposed in the inner space 710s of the chamber 710.

Referring to FIG. 3B, a tube 300 including a wall 300w defining a space 300s and a through hole 320t at an end portion of the tube 300 may be guided over a surface 212a of a pad 212 of the component 21. In some arrangements, the tube 300 is guided by a through hole 720t of a capillary head 720 and a clamp 730. The through hole 720t may be referred to as a guiding hole configured to guide the movement of the tube 300 and control the looping of the optical coupler 30 formed subsequently. Next, the tube 300 may be guided toward the surface 212a of the pad 212 along a direction DR1. In some arrangements, the inner space 710s of the chamber 710 is in vacuum. In some arrangements, the pressure within the inner space 710s of the chamber 710 is lower than 1 atm, e.g., about 10⁻⁷ torr to 10⁻⁸ torr.

Referring to FIG. 3C, an ultrasonic energy may be applied to the capillary head 720 to induce ultrasonic vibration along a direction DR2 and a direction opposite to the direction DR2 to allow the tube 300 to bond to the surface 212a of the pad 212. In some arrangements, a portion of the tube 300 is bonded to the surface 212a through recrystallization of the material from the wall 300w of the tube 300 and the material from the pad 212. The bonding process may be performed by applying the ultrasonic energy under a temperature from about 100° C. to about 200° C. In some arrangements, portions of the wall 300w are broken and pushed away to form protrusions 310p1 and 320p, and a segment 320 including a wall 320w defining a space 320s and a through hole 320t is formed. In some arrangements, protrusions 310p1 and 320p are bonded to the surface 212a through recrystallization of the materials from the protrusions 310p1 and 320p and the material from the pad 212. In some arrangements, portions of the wall 300w of the tube 300 are bonded to the surface 212a of the pad 212, and portions of the surface 212a of the pad are exposed to the spaces 300s and 320s. In some arrangements, the pressure within the inner space 710s of the chamber 710 remains lower than 1 atm, e.g., about 10⁻⁷ torr to 10⁻⁸ torr, at this stage.

According to some arrangements of the present disclosure, the bonding process is performed by applying an ultrasonic energy under a relatively low temperature from about 100° C. to about 200° C. Therefore, the structure can be prevented from being damaged by high-temperature processes.

In addition, according to some arrangements of the present disclosure, the tube 300 is bonded to the surface 212a of the pad 212 through recrystallization of the material of the wall 300w of the tube 300 and the material of the pad 212, and the tube 300 is bonded to the surface 212a of the pad 212 further through the recrystallization of the material of the protrusions 310p1 and 320p and the material of the pad 212. Therefore, the bonding interface is increased, and thus the bonding strength is further increased.

Referring to FIG. 3D, the clamp 730 may be open to allow the capillary head 720 to moved along a direction DR3 to generate a loop of the tube 300.

Referring to FIG. 3E, operations similar to those illustrated in FIG. 3B and FIG. 3C may be performed to bond the tube 300 to a surface 222a of a pad 222 of the component 22 when the pressure within the inner space 710s of the chamber 710 remains lower than 1 atm, e.g., about 10⁻⁷ torr to 10⁻⁸ torr, at this stage. In some arrangements, a segment 310 (or an optical channel) including a wall 310w defining a space 310s which is vacuum sealed may be formed. In some arrangements, a loop of the segment 310 having a loop height H1 is formed.

Referring to FIG. 3F, the tube 300 may be pulled by the clamp 730 until the tube 300 breaks to form a segment 330 that connects to the surface 222a of the pad 222. In some arrangements, the segment 330 includes the tapered structure because the segment 330 is formed by the tube 300 being pulled apart. The part of the tube 300 that becomes thinner due to the pulling and is eventually torn forms the tapered structure of the segment 330. As such, an optical coupler 30 including the segments 310, 320, and 330 may be formed.

Referring to FIG. 3G, the structure illustrated in FIG. 3F may be removed from the inner space 710s of the chamber 710, a conductive wire 40 may be formed to electrically connect the pad 110 to the pad 211, and an encapsulant 50 may be formed to encapsulate the components 21 and 22 and the optical coupler 30. As such, an electronic device 1 illustrated in FIG. 1 may be formed.

In some arrangements, the inner space 710s of the chamber 710 may be filled with a gas when forming the segment 310 of the optical coupler 30, so that the space 310s of the segment 310 is filled with the gas that is filled in the inner space 710s of the chamber 710.

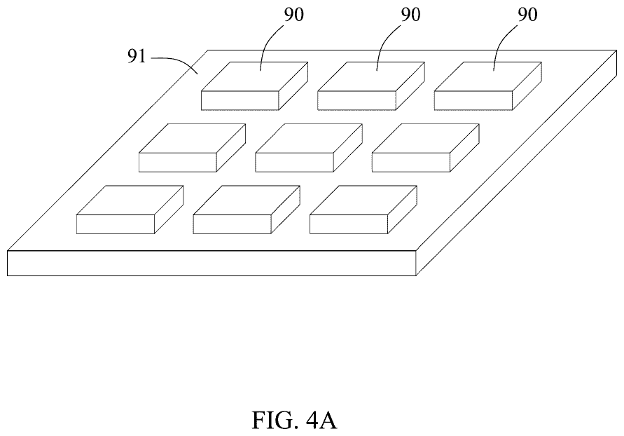

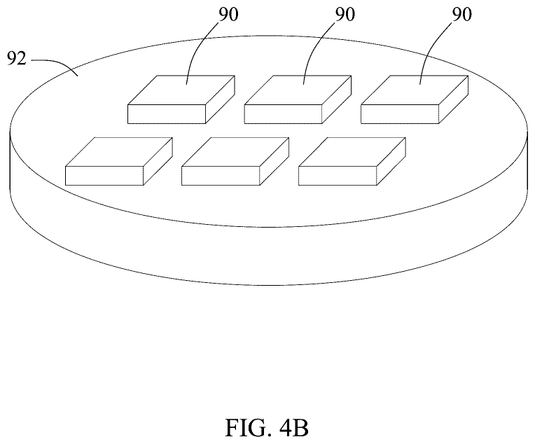

FIG. 4A and FIG. 4B illustrate different types of semiconductor package devices in accordance with some arrangements of the present disclosure.

As shown in FIG. 4A, a plurality of chips 90 or dies are placed on a square-shaped carrier 91. The square-shaped carrier 91 may be a panel. In some arrangements, the chips 90 may be or include the electronic device 1, the electronic device 2A, and/or the electronic device 2B. In some arrangements, the carrier 91 may include organic materials (e.g., molding compound, BT, PI, PBO, solder resist, ABF, PP or epoxy-based material) or inorganic materials (e.g., silicon, glass, ceramic or quartz).

As shown in FIG. 4B, a plurality of chips 90 or dies are placed on a circle-shaped carrier 91. The circle-shaped carrier 91 may be a wafer. In some arrangements, the chips 90 may be or include the electronic device 1, the electronic device 2A, and/or the electronic device 2B. In some arrangements, the carrier 92 may include organic materials (e.g., molding compound, BT, PI, PBO, solder resist, ABF, PP or epoxy-based material) or inorganic materials (e.g., silicon, glass, ceramic or quartz).

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated from by such an arrangement.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be deemed to be “substantially” the same or equal to a second numerical value if the first numerical value is within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” perpendicular can refer to a range of angular variation relative to 90° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Two surfaces can be deemed to be coplanar or substantially coplanar if a displacement between the two surfaces is no greater than 5 μm, no greater than 2 μm, no greater than 1 μm, or no greater than 0.5 μm. A surface can be deemed to be substantially flat if a displacement between a highest point and a lowest point of the surface is no greater than 5 μm, no greater than 2 μm, no greater than 1 μm, or no greater than 0.5 μm.

As used herein, the singular terms “a,” “an,” and “the” may include plural referents unless the context clearly dictates otherwise.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 104 S/m, such as at least 105 S/m or at least 106 S/m. The electrical conductivity of a material can sometimes vary with temperature. Unless otherwise specified, the electrical conductivity of a material is measured at room temperature.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. An electronic device, comprising:
a first terminal; and
an optical coupler comprising a first segment configured to optically couple to the first terminal, a second segment, and a reflective wall separating the first segment from the second segment.

2. The electronic device as claimed in claim 1, wherein the optical coupler comprises a photonic wire.

3. The electronic device as claimed in claim 1, wherein the first segment and the second segment extend in different directions.

4. The electronic device as claimed in claim 3, further comprising a second terminal spaced apart from the first terminal and configured to optically couple to the first segment.

5. The electronic device as claimed in claim 4, wherein the first terminal and the second terminal are at different elevations.

6. The electronic device as claimed in claim 4, wherein the first terminal is a portion of a first electronic component, and the second terminal is a portion of a second electronic component, and the first electronic component is spaced apart from the second electronic component.

7. The electronic device as claimed in claim 1, further comprising an electronic component, the first terminal is a portion of the electronic component, and the electronic component further comprises a third terminal electrically connecting the electronic component to an element distinct from the electronic component.

8. The electronic device as claimed in claim 7, wherein the first terminal and the third terminal are arranged on a front side of the electronic component.

9. The electronic device as claimed in claim 7, further comprising a carrier supporting the electronic component and electrically connected to the third terminal through a conductive element adjacent to a lateral side of the electronic component.

10. An electronic device, comprising:
a terminal; and
an optical coupler connected to the terminal, wherein the optical coupler comprises a first segment defining an enclosed space configured to optically couple to the terminal and a second segment defining an open space communicating with an exterior.

11. The electronic device as claimed in claim 10, wherein the optical coupler comprises a tubular structure.

12. The electronic device as claimed in claim 11, wherein the optical coupler comprises a wall structure defining the tubular structure, and a portion of the wall structure contacts a surface of the terminal.

13. The electronic device as claimed in claim 10, wherein a pressure within the enclosed space is lower than a pressure within the opening space.

14. The electronic device as claimed in claim 10, wherein the first segment comprises a wall defining the enclosed space, and a refractive index of a medium within the enclosed space is lower than a refractive index of the wall.

15. The electronic device as claimed in claim 10, wherein the second segment comprises a first end connected to the terminal and a second end opposite to the first end and defining a through hole connecting the open space to the exterior.

16. The electronic device as claimed in claim 15, wherein the second segment comprises a wall defining the open space, and the wall has a thickness decreasing in a direction toward the through hole.

17. The electronic device as claimed in claim 16, wherein the second segment further comprises a protrusion contacting the wall and a surface of the terminal.

18. An electronic device, comprising:
a first terminal;
a second terminal adjacent to the first terminal; and
an optical channel defining a vacuum passage configured to transmit an optical signal to optically couple the first terminal to the second terminal.

19. The electronic device as claimed in claim 18, wherein the first terminal comprises a first photonic pad exposed to the vacuum passage, and the second terminal comprises a second photonic pad exposed to the vacuum passage.

20. The electronic device as claimed in claim 19, wherein the first photonic pad comprises an optical waveguide, and the first terminal further comprises a photonic component configured to convert an optical signal received from the optical channel through the first photonic pad to an electrical signal.
